(19) United States
(12) Patent Application Publication
(10) Pub. No.: US 2003/0175376 A1
(43) Pub. Date: Sep. 18, 2003

(54) Extruding devices and methods thereof

(76) Inventor: Robert Jahn, Dayton, OH (US)

Correspondence Address: Killworth, Gottman, Hagan & Schaeff, L.L.P., Suite 500, One Dayton Centre, Dayton, OH, 45402-2023, US

(21) Appl. No.: 10/386,949

(22) Filed: Mar. 12, 2003

Related U.S. Application Data
(60) Provisional application No. 60/364,629, filed on Mar. 15, 2002.
(60) Provisional application No. 60/405,229, filed on Aug. 22, 2002.
(60) Provisional application No. 60/405,238, filed on Aug. 22, 2002.

(51) Int. Cl. B29C 47/54; B29C 47/12

(52) U.S. Cl. 425/191; 425/376.1

(57) ABSTRACT

Extrudable materials are provided in a pre-packaged disposable container. The container includes a first end having a dispensing aperture and a second end containing a shuttle that may be advanced within the container to dispense or extrude the contents. The shuttle is advanced towards the dispensing aperture in incremental amounts corresponding to the desired amount of contents to be extruded. Advancement of the shuttle may be accomplished using an extruding device integral with the container or from a separate extruding device. The container and shuttle are configured such that when the shuttle is advanced to a position proximate to the first end, the shuttle is locked so as to prevent rearward retraction of the shuttle back to the second end of the container. When the desired quantity of food has been prepared, the user recycles or disposes of the container, eliminating or greatly reducing the necessary amount of required cleanup.

### CROSS REFERENCE TO RELATED APPLICATIONS

This application claims priority to U.S. Provisional Patent Application Serial No. 60/364,629 filed Mar. 15, 2002; U.S. Provisional Patent Application Serial No. 60/405,229 filed Aug. 22, 2002; and U.S. Provisional Patent Application Serial No. 60/405,238 filed Aug. 22, 2002, the disclosures of which are hereby incorporated by reference.

### BACKGROUND OF THE INVENTION

The present invention relates in general to extruding devices and methods of using extruding devices, and in particular to devices and methods thereof, for sanitarily extruding flowable materials, including comestibles such as cookie dough, confections, icing, and other paste-like foodstuffs.

Extruding devices used to prepare comestibles such as cookies from cookie dough have long enjoyed popularity because of their ability to mold food items into numerous varieties of decorative designs. Further, such extruding devices can consistently produce food items of generally similar portions. This allows for example, cookies of generally the same size and shape to be repeatably formed.

While currently available extruding devices provide an enjoyable approach to making decorative cookies and other foodstuffs, the process requires that a user take considerable time and care to prepare and mix the necessary ingredients, extrude all of the necessary food items, then carefully clean and sanitize the equipment after each use. For example, one must typically disassemble and wash the extruding device thoroughly after use. This takes appreciable amounts of time, and can lead to unsanitary conditions if performed improperly.

Further, despite the consistency in the decorative shape of food items prepared using a typical extruding device, users are required to mix their own ingredients. Accordingly, the quality and taste of a food item may vary widely among users of the same or similar extruding device. Still further, should the user fail to mix the comestible to the proper consistency or properly pack the comestible into the extruding device, air pockets and other inconsistencies can result in varying sized and portioned end food items.

Extruding devices are also used to dispense a range of flowable materials such cosmetics, glues, adhesives, caulks, and other sealants. For example, relatively inexpensive caulking guns are available for dispensing beads of caulk and other sealants. While these devices are not particularly difficult to use, it does take considerable practice and skill to be able to dispense consistent and uniform beads of material. The casual user typically produces inconsistent and less than professional results. Even for the professional, typical extruding devices are sometimes inconvenient. For example, even a professional may have difficulty caulking into certain tight corners or other areas where the physical size of the caulking gun is prohibitive to convenient usage.

Accordingly, there is a need for an extruding device and a method of using the extruding device that is easy to use, quick, sanitary, and easy to clean up.

### SUMMARY OF THE INVENTION

The present invention overcomes the disadvantages of previously known extruding devices by providing a container of pre-packaged extrudable contents such as comestibles or other flowable materials, and an extruder for dispensing the contents in the container. The present invention further provides methods of using the extruder with the pre-packaged container contents in a manner that provides simple, sanitary, and consistent quality extruding with minimal cleanup.

In accordance with one embodiment of the present invention, extrudable contents including for example, comestible products such as cookie dough, noodles, cheese, peanut butter, biscuit dough, icing, confectionaries, and other extrudable or otherwise paste-like foodstuffs are provided in a pre-packaged disposable container. The disposable container is preferably generally cylindrical with a constant cross-section, includes a first end having a dispensing aperture sealed by a cap and a second end opposite the first end. Positioned internal to the container and initially oriented proximate to the second end of the container is a shuttle operative to extrude the container contents through the dispensing aperture. The container further includes a locking device operatively configured such that when the shuttle is advanced to a position immediately proximate the first end of the container, the shuttle is lockedly engaged with respect to the container body so as to prevent rearward retraction of the shuttle back to the second end of the container.

The container is installed onto a separate press such that actuation of a dispensing mechanism on the press extrudes the container contents. For example, each of the opposite ends of the container may optionally include a threaded neck portion sized and dimensioned to cooperate with a conventional, commercially available extruding press. When the press is actuated, the internal shuttle within the container advances to extrude the container contents. When the contents of the container are completely depleted, the shuttle locks in a forward engaged position indicating to the user that the container is no longer useful for extruding. Such an arrangement is beneficial for example, where it is undesirable to allow a user to reuse or otherwise recycle a container. The user recycles or disposes of the container in its entirety after the shuttle is locked. Accordingly, the present invention avoids the need to clean and sanitize the container and provides a level of convenience to the user not heretofore available.

According to another embodiment of the present invention, a container includes a first end having a dispensing aperture sealed by a cap and a second end opposite the first end. Positioned internal to the container and initially oriented proximate to the second end of the container is a shuttle that may be advanced within the container to dispense or extrude the container contents through the dispensing aperture. The container and shuttle are configured such that when the shuttle is advanced to a position immediately proximate the first end of the container, the shuttle is lockedly engaged with respect to the container body so as to prevent rearward retraction of the shuttle back to the second end of the container. The container also includes an integral extruding device operatively configured to advance the shuttle towards the dispensing aperture upon actuation of an extruding control.

According to another embodiment of the present invention, a container is preferably provided to users in a prepackaged condition with premixed container contents already present therein. For example, where the container is used to extrude comestibles, this approach eliminates the need for a user to possess a suitable recipe, and further avoids the need to mix the necessary ingredients and clean up thereafter. Further, the user need not be concerned over mixing ingredients to a particular consistency suitable for extruding as this will be taken care of by the manufacturer or packager of the container. The user extrudes the contents of the container using an extruding device (either external or integral to the container) by actuating an extruding control. Actuation of the extruding device causes a shuttle within the container to advance a predetermined distance towards the dispensing end of the container corresponding to the desired amount of container contents to be extruded. When the contents of the container are completely depleted, the shuttle is locked in a forward engaged position proximate the dispensing end of the container indicating to the user that the container is no longer useful for extruding. The user then recycles or disposes of the container in its entirety after the container contents have been extruded.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals, and in which:

FIG. 1 is a cross-sectional view of a disposable container according to an embodiment of the present invention;

FIG. 2 is an illustration of a disposable container such as the container shown in FIG. 1 being loaded into an extruding device according to an embodiment of the present invention;

FIG. 3 is a cross-sectional view of the disposable container according to FIG. 1 illustrating a shuttle in a forward, locked position;

FIG. 4 is an illustration of an extruder being loaded with a disposable container according to another embodiment of the present invention;

FIGS. 5-9 are illustrations of exemplary templates that may be used with the various embodiments of the present invention;

FIG. 10 is a cross-sectional view of a disposable container according to another embodiment of the present invention;

FIG. 11 is a cross-sectional view of a disposable container according to another embodiment of the present invention;

FIG. 12 is an illustration of the disposable container of FIG. 10 being installed on a press;

FIG. 13 is a cross-sectional view of a disposable container with integral extruding device according to an embodiment of the present invention;

FIG. 14 is an illustration of a cap for the disposable container of FIG. 13 according to an embodiment of the present invention;

FIG. 15 is a cross-sectional view of the disposable container according to FIG. 13, illustrating a shuttle locked with a shaft for extruding container contents according to an embodiment of the present invention;

FIG. 16 is a cross-sectional view of the disposable container according to FIG. 13 illustrating a shuttle in a forward, locked position;

FIG. 17 is a cross-sectional view of a disposable container with integral extruding device according to another embodiment of the present invention;

FIG. 18 is a cross-sectional view of a disposable container with integral extruding device according to another embodiment of the present invention;

FIG. 19 is a cross-sectional view of a key arrangement between the two driver components of the extruding device according to FIG. 18;

FIG. 20 is a cross-sectional view of a disposable container with an integral extruding device according to yet another embodiment of the present invention;

FIG. 21 is a view of a shuttle configuration usable with the disposable container shown in FIG. 20 according to an embodiment of the present invention; and

FIG. 22 is a view of another shuttle configuration usable with the disposable container shown in FIG. 20 according to an embodiment of the present invention.

### DETAILED DESCRIPTION OF THE PREFERRED EMBODIMENTS

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that logical and mechanical changes may be made without departing from the spirit and scope of the present invention.

### Container for Use with an Extruding Device

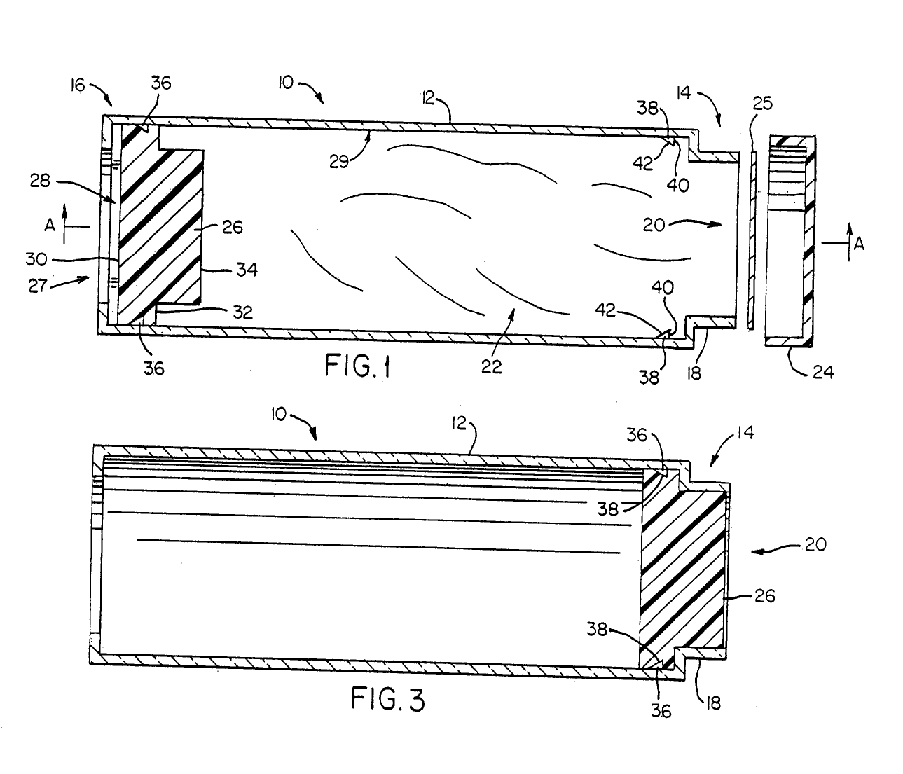

Referring to FIG. 1, a disposable container 10 suitable for carrying extrudable comestibles or other flowable materials is illustrated. The container 10 comprises a container body 12 having a first longitudinal end, or dispensing end 14, and a second longitudinal end, or extruder engaging end 16. The container body 12 can be any shape, however, it is preferably a hollow, generally cylindrical, or tube shaped structure having a substantially self-sustaining shape and generally uniform cross-section. The container body 12 may be manufactured from any number of materials. For example, according to one embodiment of the present invention, the container body 12 is manufactured from a transparent acrylic-based or plastic-based material. The transparent material allows the contents to be viewed so that users will be able to see the amount of container contents that remain during use. Also, the size of the container body 12 will likely vary depending upon the extruding device for which the container 10 is compatible and the type of contents contained therein. For example, for a typical cookie dough application, the container body 12 may be designed to hold on the order of 1-3 cups of cookie dough. Other sizes and shapes of container bodies 12 are also possible within the spirit of the present invention of course.

As shown, the extruder engaging end 16 includes a driver receiving aperture 17. The dispensing end 14 of the container body 12 comprises a neck 18 that extends axially out from the container body 12 and is spaced radially inward of the container body periphery at the dispensing end 14. An opening in the container body 12 at the neck 18 defines a dispensing aperture 20 that provides access to a storage area 22 within the container body 12. A cap 24 secures about the neck 18 until the container 10 is ready for use.

It will be appreciated that any extrudable contents can be prepackaged within the container 10 including for example, comestibles such as cookie dough, noodles, cheese, peanut butter, biscuit dough, icing, confectionaries, and other extrudable or otherwise paste-like foodstuffs. The comestible may also be colored, such as for seasonal, holiday, or festive decorative food products. While described herein with reference to extruding food items, the container 10 is also suitable for applications with other, non-food items including for example, glue, cosmetics, caulk and other sealants. Depending upon the contents within the container 10, a temporary and substantially air-tight seal may be formed when the cap 24 is properly secured to the neck 18 on the dispensing end 14 of the container body 12.

An optional barrier device 25, such as a foil seal that forms a hermetic seal with the container body 12, may be used at one or both ends of the container 10 as is known in the art. The barrier device 25 may be useful for example, where the container contents comprise materials that may dry, to prevent freezer burn, eliminate odor, and prevent contaminants from penetrating the container body 12 during transportation and storage. This allows commercial entities to prepackage and sell disposable containers 10 of cookie dough and other comestibles, even if refrigeration is required.

The container 10 further comprises a shuttle 26 that is slidably mounted within the container body 12. The shuttle 26 is preferably initially positioned within the container body 12 proximate to the extruder engaging end 16 of the container body 12, and is accessible to a suitable extruding device via a driver receiving aperture 27. The shuttle 26 may optionally be spaced inwardly from the driver receiving aperture 27 by a slight recess 28. The slight recess 28 may allow a driver from a press to suitably align with the shuttle 26 for extruding.

The shuttle 26 optionally forms a seal by engaging the inner diameter 29 of the container body 12. In certain applications, it may be preferable that the shuttle 26 forms a hermetic seal with the inner diameter 29 of the container body 12. The shuttle 26 comprises a rear abutment surface 30 for communicating with the driver of a press to advance the shuttle 26. The shuttle 26 further includes a first driving surface 32 that may be caused to apply a positive pressure to the extrudable contents stored within the container body 12 for extruding the container contents through the dispensing aperture 20 in a prescribed amount. A second driving surface 34 may be optionally mounted to, or formed integral with the first driving surface 32 of the shuttle 26. The second driving surface 34 is generally parallel to, concentric, and forward of the first driving surface 32 and serves to advance the contents through the neck 18 of the container body 12 to ensure adequate delivery thereof. Other shuttle configurations are possible and will depend, for example, upon the configuration of the container body 12 and the composition of the container contents.

When the shuttle 26 has been advanced generally to a forwardmost position proximate the dispensing end 14 of the container body 12, the shuttle 26 is lockedly engaged with respect to the container body 12 so as to prevent rearward retraction of the shuttle 26 back to the extruder engaging end 16 of the container body 12. Any number of techniques may be used to lock the shuttle 26 so long as the shuttle 26 is prevented from retracting once the shuttle 26 is locked. One exemplary locking arrangement is to include a locking device 36 about the periphery of the shuttle 26. For example, as shown, the inner diameter 29 of the container body 12 includes a corresponding locking rim 38 positioned proximate the dispensing end 14 of the container body 12. According to one embodiment of the present invention, the locking rim 38 comprises a generally annular ring having a generally sawtooth configuration that deforms as the shuttle 26 passes thereby. The locking rim 38 is configured such that a substantially flat locking surface 40 is positioned towards the dispensing aperture 20 and is arranged generally radially with respect to the axial dimension. A ramp 42 of the sawtooth extends generally from the innermost radial position of the locking surface 40 away from the dispensing aperture 20, directed angularly towards the inner diameter 29 of the container body 12. The corresponding locking device 36 of the shuttle 26 comprises a sawtooth recess that is dimensioned generally to cooperate with the locking rim 38 to lock the shuttle 26 when the locking device 36 lockably engages the locking rim 38 of the container body 12.

As the shuttle 26 passes by the locking rim 38, the ramp 42 will deflect towards the container walls to allow the shuttle 26 to pass thereby. Once the corresponding peripheral locking device 36 of the shuttle 26 registers with the locking rim 38, the sawtooth ramp 42 will snap back to shape and lock with the shuttle 26 such that the locking surface 40 prevents the shuttle 26 from retracting back to the extruder engaging end 16 of the container 10. Other locking arrangements including other snap-type configurations may also be used within the spirit of the present invention.

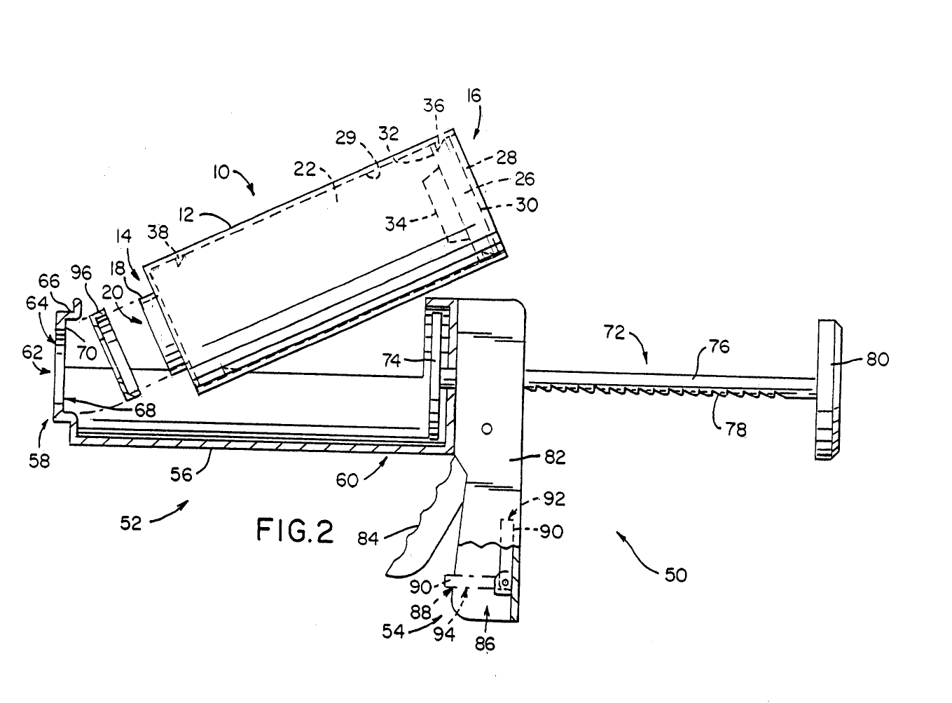

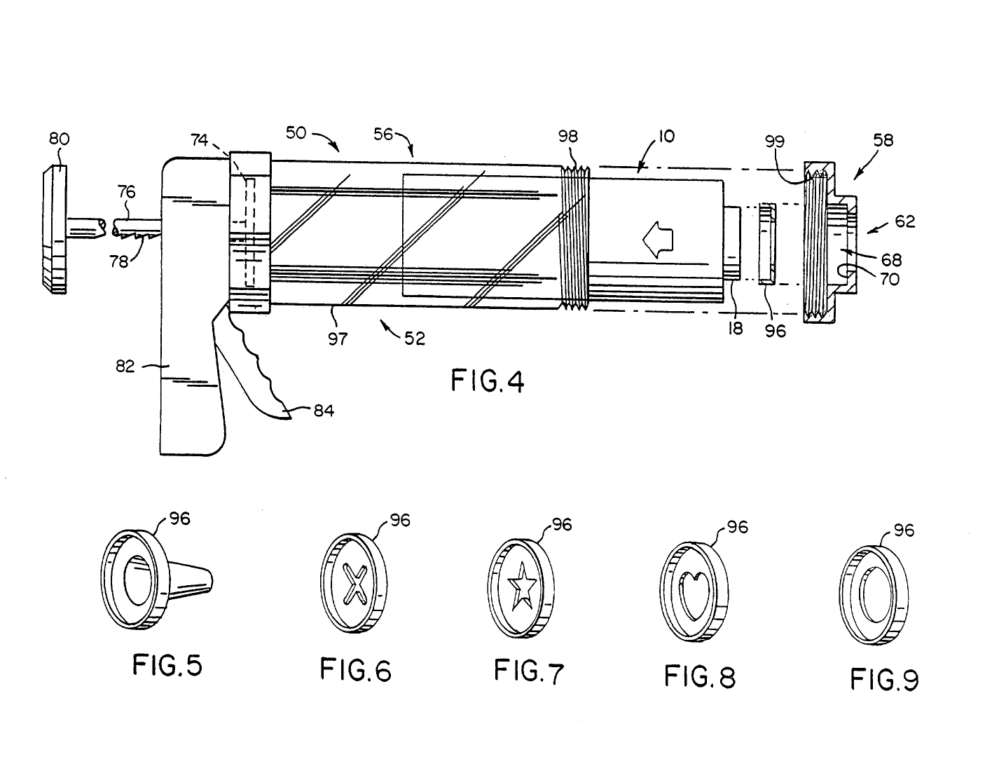

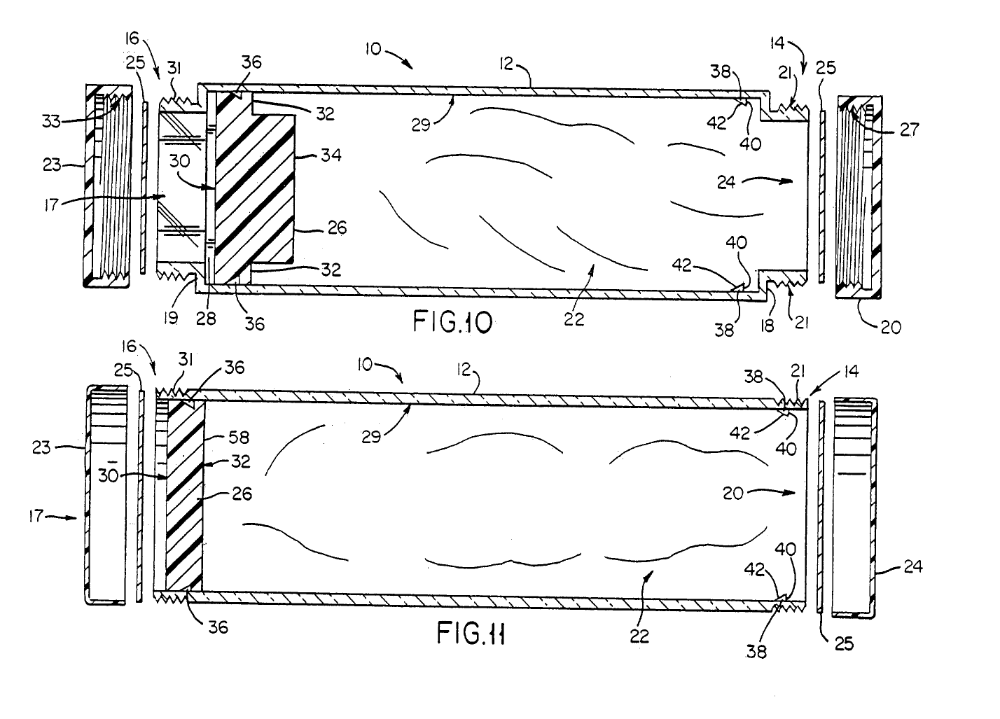

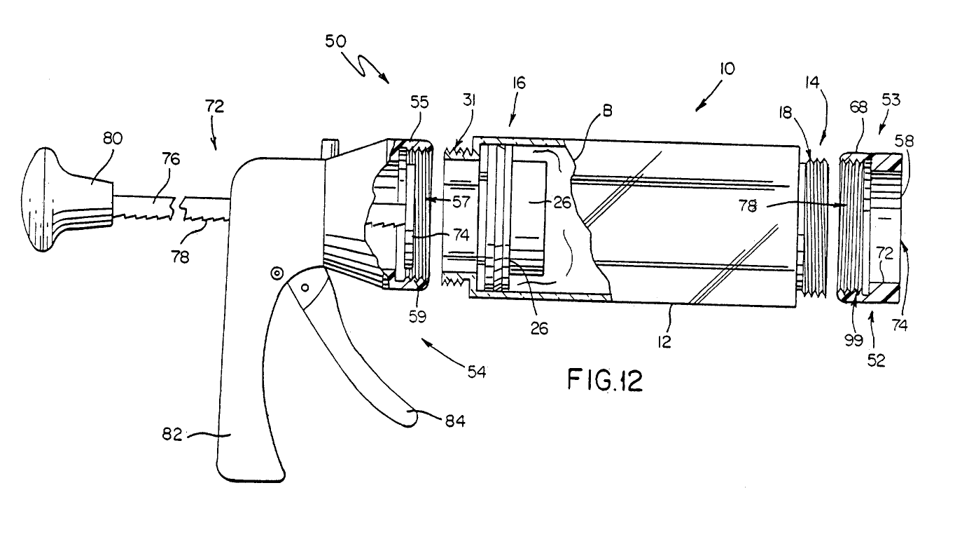

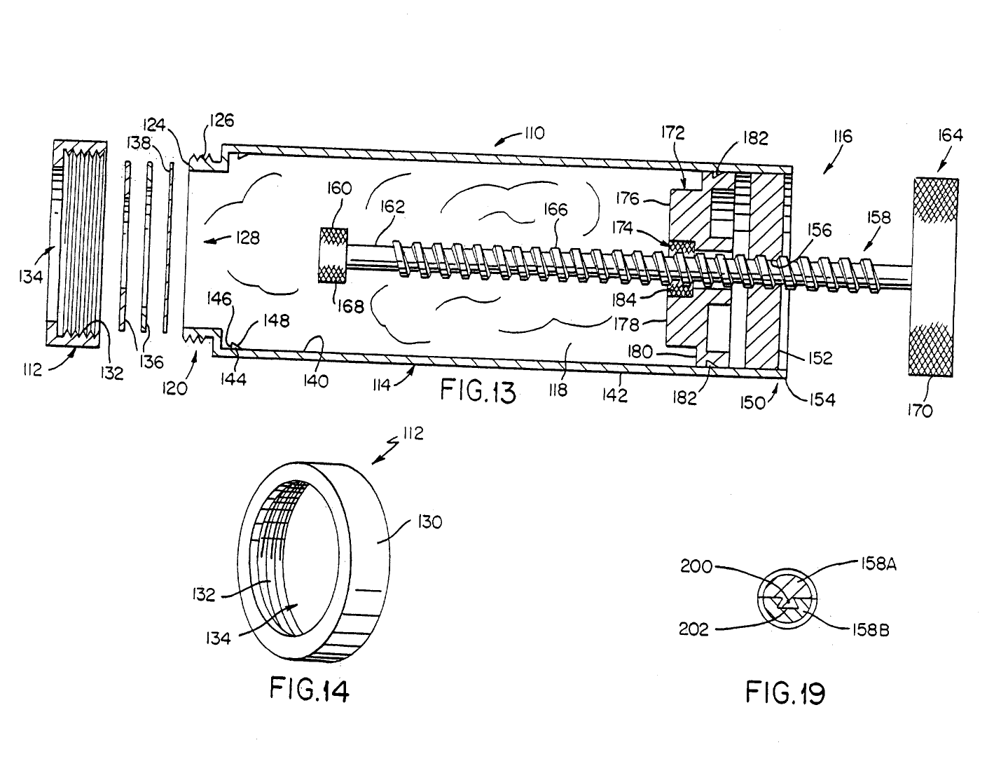

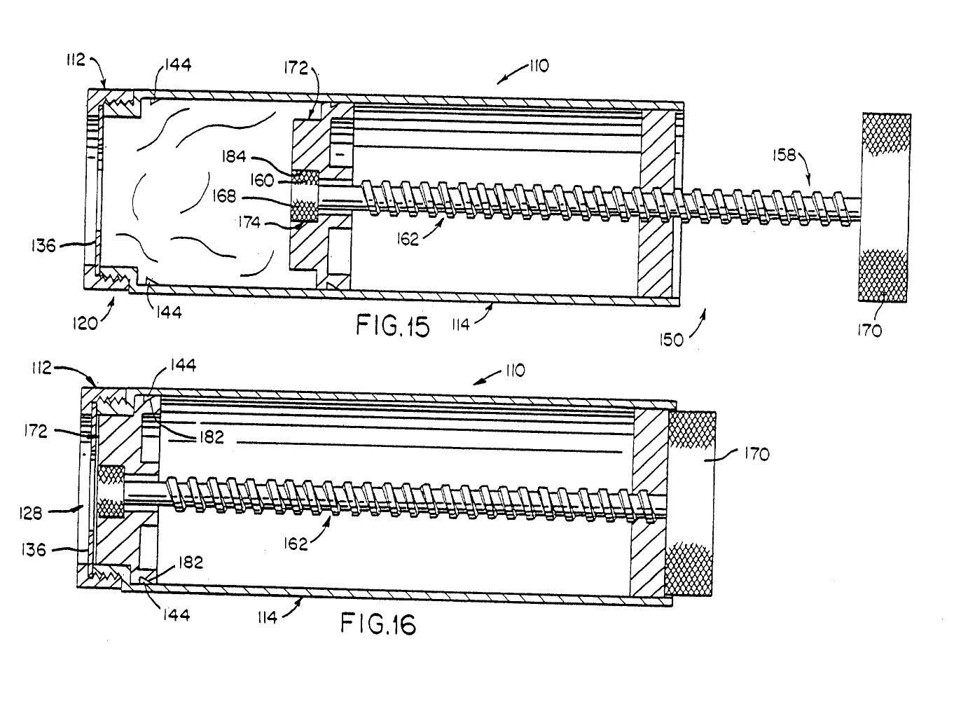

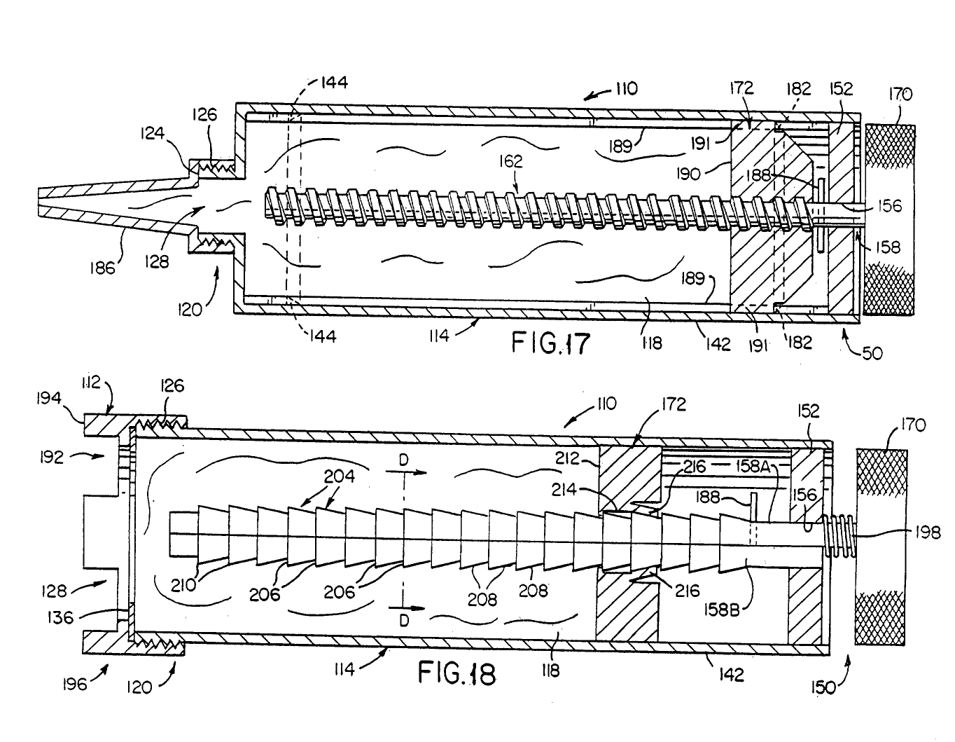

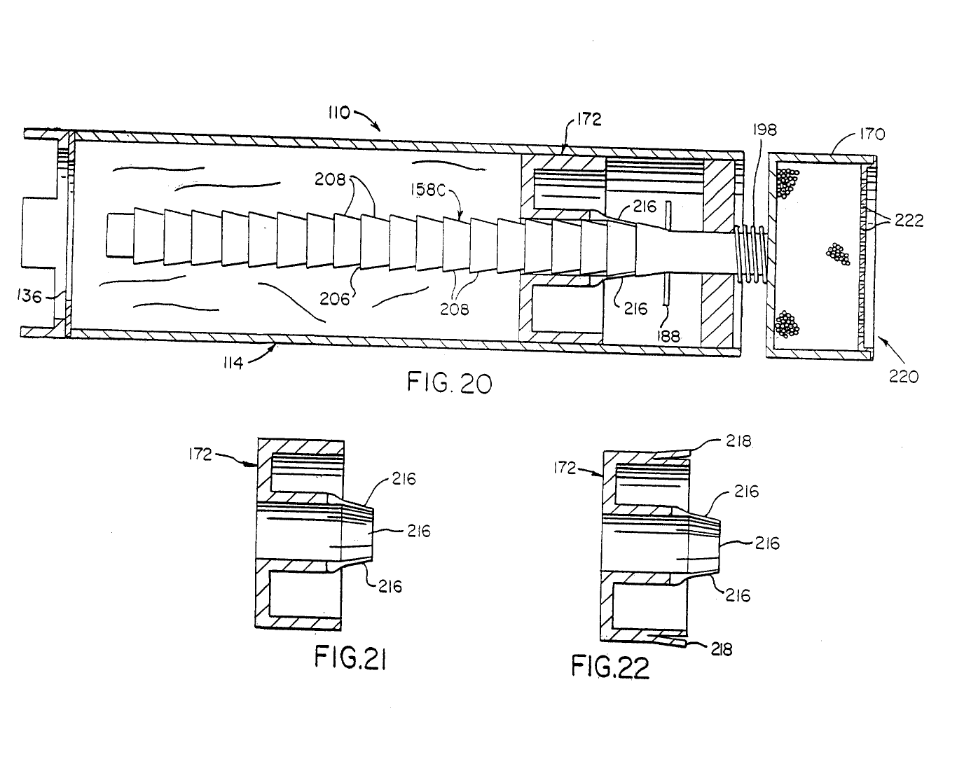

Any number of suitable extruder configurations may be used with the present invention. FIGS. 2, 4 and 12 show representative examples of extruders, however, it shall be appreciated that the present invention shall not be limited to use with the extruders illustrated, and that the container 10 may be dispensed with any practical variety of extruding devices.

Referring to FIG. 2, the extruder 50 comprises generally, a holder 52 and an actuating device 54. The holder 52 comprises a cradle 56, a forwardly disposed engaging end 58, and a rearwardly disposed engaging end 60. The cradle 56 as illustrated, is shaped generally as an open frame half cylinder. Other geometries are possible within the spirit of the present invention. Also, extruders are also sometimes referred to as extruding devices or presses, and as such, these terms are used interchangeably herein. The open frame half cylinder may be desirable however, because it facilitates easy loading and unloading of containers 10 as will be explained more fully herein.

The forwardly disposed engaging end 58 comprises an extruding port 62 that defines generally, a discharge area 64 for extrudable material within the container 10. As illustrated, the extruding port 62 is generally annular, and offset from the cradle 56, or open frame half cylinder by a flange 66 defining a neck receiving recess 68. The inside surface of the extruding port 62 defines an abutment surface 70 for engaging the container 10.

The rearwardly disposed engaging end 60 of the extruder 50 comprises a driver assembly 72 including a driver 74, a push rod 76 having a plurality of ratchet teeth 78, and a ratchet arm 80. The push rod 76 is arranged to allow the driver 74 to axially reciprocate within the cradle 56. Basically, the driver 74 is urged against the rear abutment surface 30 of the shuttle 26 of a properly installed container 10. Advancing the driver 74 toward the forwardly disposed engaging end 58 of the holder 52 advances the shuttle 26 within the container 10 by a corresponding amount, and thus extrudes comestible through the dispensing aperture 20 of the container body 12, and through the extruding port 62 of the extruder 50 to form for example, patterned ready to bake foodstuffs.

The actuating device 54 of the extruder 50 comprises generally, a handle 82 and a trigger 84. Applying pressure to the trigger 84 advances the push rod 76, and hence the driver 74. Preferably, the travel distance of the trigger 84 when actuated, affects the total distance advanced by the push rod 76, such that the amount of container contents extruded can be varied by the amount of pressure, or distance the trigger 84 travels when actuated. Optionally, the handle 82 includes a recessed portion 86 that houses a retractable, or pivotable extruding control 88. For example, as illustrated, a stop 90 is hingedly supported within the recessed portion 86 of the handle 82. The stop 90 is pivotable from a first position 92 wherein the stop 90 is contained within the recessed portion 86 of the handle 82, to a second position 94 generally orthogonal to the first position 92. In the second position 94, the stop 90 limits the range of trigger motion. This is advantageous for example, where one is making thin cookies, and uniformity is of concern. By pivotally rotating the stop 90 to the first position 92, the trigger 84 enjoys a greater range of movement allowing the extruder 50 to advance more comestible for thicker food products.

It will be appreciated that the size and shape of the extruder 50 will depend upon a number of factors. For example, where the container 10 has a larger cross-section, a shorter tool can be used. This may provide a more compact tool that allows more control when wielded by a user, because the larger the cross-section of the container 10, the more container contents that may be extruded for a given distance of travel by the driver 74.

As an alternative example, the push rod 76 may be replaced by a threaded shaft (not shown) that is manually cranked, or automatically cranked, such a by a manual or motorized drive mechanism (not shown). Any number of other drive mechanisms are possible within the spirit of the present invention, so long as the drive mechanism is arranged to selectively advance the shuttle 26 within a container 10 that has been properly installed in the extruder 50.

In operation, the cap 24 is removed from a container 10 containing extrudable contents, for example, a comestible such as cookie dough. An optional template 96 is either positioned over the neck 18 of the container 10, or alternatively, the template 96 is inserted into the cradle 56 and positioned within the neck receiving recess 68 and against the abutment surface 70 of the extruding port 62. The container 10 is then introduced into the extruder 50 by positioning the neck 18 of the container 10 against the abutment surface 70 (or optional template 96 that is placed against the abutment surface 70). The container body 12 is then angled into the extruder 50 such that the container body 12 rests against the cradle 56. The driver 74 is then advanced to engage the rear abutment surface 30 of the shuttle 26 within the container 10. Accordingly, the container 10 is now secured within the extruder 50.

A user squeezes the trigger 84 of the extruder 50 to advance the shuttle 26 thus extruding the disposable container contents. When the container 10 is depleted, the user retracts the driver 74, for example by turning the ratchet arm 80 to release the driver 74. The push rod 76 and driver 74 are slid back towards the rearwardly disposed engaging end 60 of the cradle 56, and the container 10 is released out of the holder 52 and recycled or disposed of. The user may have to optionally wash any used templates 96. Otherwise, cleanup is done, because the extrudable comestible does not contact the extruder 50. The container 10 is disposed of and cannot be reused, repackaged or refilled. If the container 10 is not depleted of its contents, the cap 24 may be re-secured to the container 10, and the container 10 may be stored for later use.

Referring to FIG. 3, when the container contents are completely extruded, the locking rim 38 of the container body 12 lockably engages with the locking device 36 of the shuttle 26. After the shuttle 26 is locked, the shuttle 26 cannot be returned to the extruder engaging end 16 of the container 10. As such, the shuttle 26 is suspended proximate the dispensing aperture 20. Accordingly, the container 10 cannot be refilled and is no longer of use as an extruder container. The container 10 may then be thrown away or otherwise disposed of.

The extruding device in FIG. 4 is similar to that discussed with reference to FIG. 2. As such, like structure is indicated with like reference numerals. Referring to FIG. 4, the extruder 50 according to another embodiment of the present invention comprises a holder 52 having a cradle 56 comprising a generally cylindrical shell 97 that includes a male threaded end portion 98. The forwardly disposed engaging end 58 of the holder 52 comprises a complimentary female threaded member 99 and is threadedly detachable from the cylindrical shell 97. In use, the forwardly disposed engaging end 58 of the extruder 50 is unscrewed from the cylinder shell 97. An optional template 96 is either positioned over the neck 18 of the container 10, or inserted into the neck receiving recess 68 against the abutment surface 70 of the extruding port 62. The container 10 is then slid into the cylindrical shell 97, and the forwardly disposed engaging end 58 is threaded back onto the cylinder shell 97. When the extruding process is complete, a user unscrews the forwardly disposed engaging end 58 from the cylinder shell, removes the container 10, and recycles or disposes of it. Otherwise, the extruder 50 shown in FIG. 4 is similar to the extruder described with reference to FIG. 2.

Sometimes, it is desirable to dispense ingredients in a thin or otherwise beaded strip. For example, where one wished to dispense patterned icing, cookie sticks, candy canes, pretzels, or for other cake or cookie decorating, an appropriate nozzle is required. Referring to FIG. 5, a nozzle template 96 may be provided that includes a nozzle portion that is inserted through the extruding port of a suitable extruder. FIGS. 6-9 illustrate examples of patterns that may be implemented with various templates 96. These patterns are presented by way of illustration and not by way of limitation, to show some exemplary configurations. Moreover, while shown with rims, the templates may be substantially flat, contoured or any other shape.

The container 10 may further be furnished with one or more templates 96 stored within the container body 12 proximate the second longitudinal end 16, and abutting the shuttle 26, for example, in the recess 28 described above with reference to FIG. 1. This arrangement provides a convenient means to store the templates 96. In use, the templates 96 may be removed from the container body 12 of the container 10, or alternatively, one or more templates 96 may be left in place. Under such arrangements, the driver of an extruding device (not shown) abuts the template 96. After extruding is complete, the user may then dispose of the container 10 and the templates 96 in their entirety and have little or no mess to clean up.

Referring to FIG. 10, the neck 18 may optionally include a male threaded surface 21 that is designed to be compatible with corresponding threaded lids of associated presses. The cap 20 is thus shown with a complementary female threaded surface 27 configured to threadably receive the male threaded surface 21 of the neck 18. The container 10 may also optionally include a neck 19 that extends axially out from the container body 12 and is spaced radially inward of the container body periphery at the extruder engaging end 16. A cap 23 may optionally secure about the neck 19 until the container 10 is ready for use. The neck 19 includes a male threaded surface 31 for securing the container 10 to a compatible press. The cap 23 optionally includes a female threaded surface 33 configured to threadably receive the male threaded surface 31 of the neck 19. Further, an optional barrier device 25 such as a foil seal temporarily forms a hermetic seal about the neck 19.

Referring to FIG. 11, the container body 12 according to another embodiment of the present invention does not include either necks 18 or 19 shown in FIG. 10. The container body 12 includes a male threaded surface 21 at the dispensing end 14, however, the corresponding cap 20 is not threaded. Rather, the cap 20 simply snaps on and off the container body 12 in lieu of threadably securing thereto. Likewise, the cap 23 snaps on and off the male threaded surface 31 at the extruder engaging end 16 of the container body 12. Also, because the container body 12 does not contain a neck or any tapered or otherwise narrowed portions, the shuttle 26 includes only the first driving surface 32.

The extruding device in FIG. 12 is similar to that discussed with reference to FIGS. 2 and 4. As such, like structure is indicated with like reference numerals. Referring to FIG. 12, an exemplary extruding device 50 suitable for use with the container 10 as illustrated in either FIG. 10 or 11 is illustrated. Note that a cradle as illustrated in the extruding devices shown in FIGS. 2 and 4 is not required with this construction. Rather, the holder 52 comprises a bottom ring 53 that holds nozzles, templates, disks, or other decorative patterning devices. The bottom ring 53 attaches to the dispensing end 14 of the container body 12. The actuating device 54 includes a top ring 55 that includes a recessed portion 57. The inner walls of the recessed portion 57 include a female threaded portion 59. The top ring 55 attaches to the extruder engaging end 16 of the container body 12. Otherwise, the extruding device 50 operates as described above with reference to FIGS. 2 and 3.

### Container with Integral Extruding Device

Referring to FIG. 13, a disposable container 110 with integral extruding device includes a cap 112 that is attached to a container body 114 at one end thereof. An integral extruding device 116 is disposed at the end of the container body 114 opposite the cap 112. The container body 114 contains a storage compartment 118 for holding flowable or otherwise extrudable contents. A first longitudinal end portion, or dispensing end portion 120 of the container body 114 includes a securing mechanism 122 for securing the cap 112 thereto. For example, the dispensing end portion 120 of the container body 114 may include a neck 124 that extends axially out from the container body 114. The outer surface of the neck 124 includes a male threaded surface 126. The neck 124 defines a frame for a dispensing aperture 128 that provides access to the storage compartment 118 of the container body 114.

Referring to FIGS. 13 and 14 generally, the cap 112 has an annular wall 130 that includes a female threaded surface 132 on the inside thereof. The female threaded surface 132 is configured to threadably receive the male threaded surface 126 of the neck 124. The cap 112 also has an opening 134 therethrough. This allows a convenient manner for securing material shaping devices such as templates 136 to the container 110 between the cap 112 and the neck 124. The templates 136 may also optionally be stored between the cap 112 that the neck 124 of the container body 114 when the container 110 is not in use. Also, depending upon the contents of the container 110, it may be advantageous to include barrier device 138, such as a hermetic foil seal, to provide a temporary seal. The inner surface 140 of the container sidewall 142 includes a locking rim 144 positioned proximate the dispensing end portion 120 of the container body 114. The locking rim 144 is similar to the locking rim described with reference to FIG. 1 and includes a generally flat locking surface 146 and a ramp 148.

A second longitudinal end portion 150 of the container body 114 provides the general location for operation and engagement of the extruding device 116. The second longitudinal end portion 150 includes a back member 152 that closes off the container body 114. The back member 152 is preferably sealingly fixed to the container sidewall 142 proximate an edge portion 154 of the second longitudinal end portion 150. The back member 152 includes an aperture 156 therethrough, which is arranged to threadably receive a driver assembly 158.

The driver assembly 158 includes a male locking member 160, a shaft 162 and an actuation mechanism 164. As shown, a substantial portion of the shaft 162 defines a worm gear, having a threaded surface profile 166. The shaft 162 is threadably received through the aperture 156 in the back member 152. The male locking member 160 may optionally include a textured surface 168. For example, the male locking member 160 may include knurls, protrusions, bumps, serrations, or other features that provide an enhanced locking function as will be described more fully herein. The actuation mechanism 164 comprises a handle 170 that is fixedly secured to the shaft 162 such that rotation of the handle 170 causes unitary rotational motion of the shaft 162. As such, rotation of the handle 170 in a first direction causes the shaft 162 and thus the male locking member 160 to retract towards the second longitudinal end portion 150 of the container body 114 in a generally axial direction. Rotation of the handle 170 in a second direction causes the male locking member 160 to advance forward towards the dispensing end portion 120 of the container body 114 in a generally axial direction.

A shuttle 172 is positioned within the container body 114 proximate the back member 152 and is threadably received along the shaft 162 of the driver assembly 158. The shuttle 172 is slidably mounted in the container body 114 so as to traverse at least a substantial portion of the length of the container 110. The shuttle 172 includes a female locking member 174 that is sized and dimensioned to receive the male locking member 160 of the driver assembly 158. As illustrated, the shuttle 172 includes a first driving surface 178 generally parallel to and forward to a second driving surface 180. The first and second driving surfaces 178,180 may be caused to apply a positive pressure to the container contents during extruding operations to force the container contents through the dispensing aperture 128 in a prescribed amount, and are generally concentric and oriented such that the first driving surface 178 has an outer perimeter that is sized to pass into the dispensing aperture 128. The shuttle 172 also includes a peripheral locking device 182 about an edge thereof. The peripheral locking device 182 is arranged to cooperate with the locking rim 144 on the inner surface of the container sidewall 142 in a manner similar to that of the shuttle described above with reference to FIG. 1.

In use, the cap 112 is removed from the disposable container body 114. The foil seal 138 is peeled from the neck 124 and is disposed of. An optional template 136 is brought into position with respect to the dispensing aperture 128, and the cap 112 is reinstalled onto the container body 114. The handle 170 is then rotated in the first direction to retract the driver assembly 158 and hence the male locking member 160 rearwardly towards the shuttle 172.

Eventually, after transitioning the driver assembly 158 axially in a rearward direction, the male locking member 160 is recessed into, and lockably received by the female locking member 174 of the shuttle 172. For example, the female locking member 174 may contain annular serrated saw tooth shaped projections 184 that flex and deform locking with projections on the textured surface 168 of the male locking member 160 as the driver assembly 158 is retracted. Once the female locking member 174 lockably receives the male locking member 160, advancement of the shaft 162 by rotation of the handle 170 in the second direction causes the shuttle 172 to advance forward in unitary axial motion with the male locking member 160 as illustrated in FIG. 15.

Rotating the handle 170 in the second direction extrudes the container contents. The amount of turns will determine the amount of contents extruded. Referring to FIG. 16, when the device contents are completely extruded, the locking rim 144 of the container body 114 lockably engages with the peripheral locking device of the shuttle 172. After the shuffle 172 is locked, rotation of the handle 170 in the first direction will not retract the shuttle 172. As such, the shuttle 172 is suspended proximate the dispensing aperture 128. Accordingly, the container 110 cannot be refilled and is no longer of use as an extruding device. The container 110 may then be thrown away or otherwise disposed of.

Referring to FIG. 17, the disposable container 110 with integral extruding device according to another embodiment of the present invention includes a cap that defines a nozzle 186. The nozzle 186 may be preferable in certain circumstances, such as where one wishes to dispense ingredients in a thin or otherwise beaded strip. For example, for patterned icing, cookie sticks, candy canes, pretzels, or for other cake or cookie decorating, an appropriate nozzle 186 is required. A nozzle 186 is further often advantageous for dispensing caulk, glue, sealants, and other paste-like substances. The nozzle 186 and cap 112 may, of course, be freely interchanged on any of the container embodiments disclosed herein.

The container housing in FIG. 17 is similar to that discussed with reference to FIG. 13. As such, like structure is indicated with like reference numerals. However, the device in FIG. 17 includes a different shuttle and driver configuration shown in FIG. 13. Just inside the container body 114 proximate the back member 152, a stop 188 is provided on the driver assembly 158 to maintain the driver assembly 158 generally in an axially fixed position. The driver assembly 158 further comprises a threaded shaft 162 that extends into the container body 114 and projects generally towards the dispensing end portion 120 of the container body 114.

A shuttle 172 is positioned within the container body 114 proximate the back member 152. The shuttle 172 is slidably mounted in the container body 114 so as to traverse the length of the container 110. The shuttle 172 is further threadably received along the shaft 162. The shuttle 172 includes a face 190 that may be caused to apply a positive pressure to the container contents during extruding operations to force the container contents through the dispensing aperture 128 in a prescribed amount. The shuttle 172 also includes a peripheral locking device 182 about an edge thereof. The peripheral locking device 182 is arranged to cooperate with the locking rim 144 to lock the shuttle 172 when the shuttle 172 reaches a predetermined forward disposed position within the container body 114.

Also, to properly advance the shuttle 172 within the container body 114, it may be necessary to prevent the shuttle 172 from rotating in cooperation with rotation of the threaded shaft 162. Under this arrangement, the container body includes at least one shuttle guide 189. As illustrated, the shuttle guide 189 comprises two keys, which are ribs that extend axially along the inside surface of the container body 114. The shuttle 172 includes corresponding shuttle guide receivers 191 that cooperate with the shuttle guide 189 to resist rotation of the shuttle 172. Any number of other configurations may also be used to ensure that the shuttle 172 properly advances along the threaded shaft 162.

In use, rotation of the handle 170 in the first direction rotates the shaft 162 thus axially advancing the shuttle 172 therealong. Rotation of the handle 170 in the second direction retracts the shuttle 172 axially along the shaft 162. However, once the shuttle 172 has been advanced to extrude the container contents, the locking rim 144 of the container body 114 lockably engages with the peripheral locking device 182 of the shuttle 172. After the shuttle 172 is locked, rotation of the handle 170 will not retract the shuttle 172. As such, the shuttle 172 is suspended proximate the dispensing aperture 128. Accordingly, the container 110 cannot be refilled and is no longer of use as an extruding device. The container 110 may then be thrown away or otherwise disposed of.

Referring to FIG. 18, a disposable container 110 with integral extruding device according to yet another embodiment of the present invention is illustrated. Many of the features and aspects of this embodiment are similar to those features and aspects discussed with reference to FIGS. 13-17. As such, like structure is indicated with like reference numerals. The disposable container 110 with integral extruding device includes a cap 112 that is attached to a container body 114 at one end thereof. An extruding device 116 is disposed at the end of the container body 114 opposite the cap 112. The cap 112 as shown comprises a platform 192 having projections 194 axially extending therefrom defining a base 196. The base 196 is configured such that the container 110 may be stood upright so as to be supported by the cap 112 generally orthogonal to a work surface and in spaced relation therefrom. As such, the container 110 is self-supporting and self aligning. Extruded material contents thus dispense from the container 110 generally normal to, and in relatively close relation to the work surface. This assists the operator in producing uniform and consistent results. Of course, this cap configuration may be used with the other container configurations disclosed herein.

The device in FIG. 18 includes a different shuttle and driver configuration that that shown in FIGS. 13-17. A first driver 158A is received through the aperture 156. A handle 170 is secured to the end of the first driver 158A exterior to the container body 114 and is generally maintained in a fixedly spaced relation a predetermined distance from the back member 152 by a biasing spring 198 that exerts a force between the back member 152 and the handle 170. The first driver 158A includes a stop 188 that serves to limit rearward retraction of the first driver 158A and handle 170 due to the force exerted by the biasing spring 198. Just inside the container body 114 proximate the back member 152, a stop 188 is provided on the first driver assembly 158A. The handle 170 exterior to the container body 114, and the stop 188 interior to the container body 114 thus serve to limit the range of motion of the first driver 158A about the axial direction.

The first driver 158A is engaged with a second driver 158B such that the first and second drivers 158A, 158B interact as an integral unit. Referring to FIG. 19, the first driver 158A includes a first key 200 that is received in a first locking channel 202 of the second driver 158B. Under this arrangement, the first driver 158A reciprocably traverses axially along the first locking channel 202 of the second driver 158B. However, the locking relationship of the first key 200 with respect to the first locking channel 202 prevents lateral or other ranges of motion that would allow the first driver 158A from separating or otherwise pulling apart from the second driver 158B. Referring back to FIG. 18, the second driver 158B remains in a generally fixed position. For example, the second driver 158B is secured to the back member 152 and cantilevers therefrom such that the second driver 158B is generally stationary.

Each of the first and second drivers 158A, 158B include indexing steps 204 arranged to align substantially in a corresponding relationship. For example, each of the first and second drivers 158A, 158B include a series of indexing steps 204 defined generally by a radially extending platform 206 and a riser 208 that extends axially and angularly from an inward disposed position to the outermost edge 210 of the platform 206. Each indexing step 204 is generally uniform such that the outermost axial edge 210 of each indexing step 204 extends a generally uniform radial dimension from a central axis of the container 110.

A shuttle 172 is positioned within the container body 114 proximate the back member 152, and is axially disposed about the first and second drivers 158A, 158B. An aperture 214 passes through the shuttle 172 along the axial dimension and the first and second drivers 158A, 158B pass therethrough. The shuttle 172 further comprises is resilient indexing legs 216 that face rearwardly and project opposite the face of the shuttle 172. The indexing legs 216 are arrayed generally circumferentially about the shuttle 172 and are oriented generally conformally to the risers 208 on the indexing steps 204 disposed along the first and second drivers 158A, 158B. The indexing legs 216 further engage the platform 206 of the first and second drivers 158A, 158B.

In use, the container 110 is positioned on a work surface. The handle 170 is then depressed generally in the axial direction towards the dispensing end of the container body 114. Pressing the handle 170 causes the biasing spring 198 to compress, and the first driver 158A to project axially towards the dispensing end portion 120. As the first driver 158A advances towards the dispensing end portion 120, the platform 206 of the indexing step 204 of the first driver 158A pushes the associated indexing leg 216, and hence the shuttle 172 forward so as to advance or index the shuttle 172 towards the dispensing aperture 128 in unison with the first driver 158A. The indexing legs 216 of the shuttle 172 about the second driver 158B deform or otherwise deflect as the indexing legs 216 follow the riser 208 allowing the shuttle 172 to transition incrementally relative to the second driver 158B. As pressure is relieved from the handle 170, the biasing spring 198 pushes the handle 170 axially away from the dispensing aperture 128. However, the indexing legs 216 of the shuttle 172 about the second driver 158B snap to the closest platform 206 of the indexing steps 204 in a rearward direction. As such the second driver 158B limits the retraction of the shuttle 172.

As the first driver 158A retracts, the indexing legs 216 of the shuttle 172 about the first driver 158A deflect as the risers 208 of the first driver 158A pass by, allowing the first driver 158A to return to a default position under the force of the biasing spring 198. As such, for each engagement of the handle 170, the shuttle 172 indexes incrementally towards the dispensing aperture 128. The configuration of the first and second drivers 158A, 158B serve as a portion control to adjust the amount of contents are extruded in each operation. The second driver 158B further defines a locking device to restrict rearward retraction of the shuttle 172.

The arrangement and cooperation of the first and second driver 158A, 158B prevents the retraction of the shuttle 172 towards the second longitudinal end 150. As such, the locking rim 144 and corresponding peripheral locking device of the shuttle 172 discussed with the embodiments previously described may optionally be omitted. However, as a secondary measure, a locking rim 144 may be included on the inside wall of the container body 114 positioned proximate the dispensing end portion 120 of the container body 114 and arranged to receive a corresponding peripheral locking device on the shuttle 172 as described more fully above.

The first and second drivers 158A, 158B may be replaced with a single driver 158C as shown in FIG. 20. Under this arrangement, the driver 158C reciprocates axially in uniform axial motion with the handle 170. The driver 158C includes a stop 188 that serves to limit rearward retraction of the driver 158C and handle 170 due to the force exerted by the biasing spring 198.

Referring to FIGS. 20 and 21 generally, the indexing legs 216 of the shuttle 172 should be flexible enough so that when the driver assembly 158C traverses rearwardly as the bias spring 198 decompresses, the shuttle 172 remains axially fixed within the container 110. Axially positioned retention of the shuttle 172 is often aided by the forces within the container 110 that is suitably filled with a flowable material. The indexing legs 216 are thus configured to deflect against a riser 208 as the driver assembly 158C retracts. The indexing legs 216 snap to next closest platform 206 such that the indexing legs engage the platform 206 and the container 110 is ready for a next usage. Referring to FIG. 22, the shuttle 172 may also include shuttle flanges 218 arranged about the periphery of the shuttle 172. The shuttle flanges 218 serve to prevent container contents from slipping between the interface between the shuttle 172 and the inner sidewalls of the container body 112.

Also, the cap 112 described with reference to FIG. 18 is shown in FIG. 20 as being formed integral with the container body 114. Under this arrangement, the template 136 may be permanently installed to the container body 112. It should be appreciated that any of the previous embodiments may also include the cap formed integral with the container body, and that the embodiment described with reference to FIG. 20 may alternatively include a cap threadably received by the container body.

The handle 170 may also have a hallowed out portion that can serve as a storage and/or dispensing device. For example, the handle may comprise a major surface 220 having a plurality of apertures 222 therethrough. Sprinkles, icing, candies or other items may be dispensed therefrom by tipping and shaking the device. A lid or other flap may be used to seal closed the apertures 222 when a user is not dispensing from the handle 170.

With respect to the various embodiments described herein, a user obtains an appropriate container that corresponds to the type of contents to be extruded. For example, if the container is packaged with a comestible, then the container filled with premixed material may be purchased at a grocery store or similar outlet. The container 10 allows retail sellers to prepare extrudable comestibles that provide consistent flavor and taste, in a cost effective manner. This approach eliminates the need for a user to poses a suitable recipe, and further avoids the need to mix the necessary ingredients and clean up thereafter. Further, the user need not be concerned over mixing ingredients to a particular consistency suitable for extruding. Accordingly, tremendous timesavings are realized, while reducing and trivializing the skill level required to prepare the appropriate foodstuffs.

Having described the invention in detail and by reference to preferred embodiments thereof, it will be apparent that modifications and variations are possible without departing from the scope of the invention defined in the appended claims.

What is claimed is:

1. A container comprising:
a generally elongate body including a first end having a dispensing aperture and a second end opposite said first end;
a flowable material contained within said generally elongate body;
a shuttle positioned within said body initially oriented proximate to said second end of said body, said shuttle operative to extrude said flowable material through said dispensing aperture; and
a locking device operatively configured to lock said shuttle when said shuttle is advanced to a position within said body proximate to said first end so as to prevent rearward retraction of said shuttle back to said second end of said container.

2. The container according to claim 1, wherein said locking device comprises a rim provided along an inner wall of said body positioned proximate to said first end, wherein said shuttle further comprises a locking recess that corresponds generally to said rim.

3. The container according to claim 2, wherein said rim is annular and generally sawtooth shaped and said locking recess of said shuttle is disposed about the periphery thereof.

4. The container according to claim 1, further comprising an extruding device arranged to cooperate with said container and engage said shuttle for extruding said flowable material from said container.

5. The container according to claim 4, wherein said extruding device includes an extruding control arranged to adjust the amount of said flowable material extruded upon actuation of said extruding device.

6. The container according to claim 4, wherein said first and second ends of said container are threaded and said container is dimensioned so as to cooperate with a top ring and a bottom ring of said extruding device.

7. The container according to claim 1, further comprising at least one detachable template arranged to cooperate with said dispensing aperture to form said flowable material to a desired shape.

8. The container according to claim 7, wherein said at least one template is stored between said dispensing aperture and a cap temporarily secured to said first end of said body prior to use of said container.

9. The container according to claim 7, wherein said at least one template is stored behind said shuttle prior to use of said container.

10. The container according to claim 1, further comprising a hermetic seal arranged about at least one of said first and second ends of said body.

11. The container according to claim 1, wherein container further comprises an integral extruding device.

12. The container according to claim 11, wherein:
said integral extruding device comprises:
a shaft that passes generally axially through said body;
an actuation mechanism coupled to said shaft external to said body such that rotation of said actuation mechanism causes unitary rotational motion of said shaft; and
a first locking member arranged on a forwardmost end portion of said shaft within said body; and
said shuttle comprises:
an aperture therethrough, said shuttle arranged such that said shaft passes through said aperture; and
a second locking member generally concentric with said first locking member of said shaft, wherein said shuttle is initially positioned proximate said second end of said body and said actuation mechanism may be operated such that said first locking member on said shaft is brought into cooperative engagement with said second locking member on said shuttle, thereafter said shuttle traverses axially within said body in unitary axial motion with said shaft unless said locking device has engaged said shuttle.

13. The container according to claim 11, wherein:
said integral extruding device comprises:
a shaft that passes generally axially through said body; and
an actuation mechanism coupled to said shaft external to said body such that rotation of said actuation mechanism causes unitary rotational motion of said shaft, said shaft configured to rotate within said body and is generally inhibited from axial displacement with respect to said body; and
said shuttle comprises an aperture therethrough, said shuttle arranged such that said shaft passes through said aperture, wherein said shuttle is initially positioned proximate said second end of said body and said actuation mechanism may be operated such that rotation of said shaft causes axial displacement of said shuttle unless said locking device has engaged said shuttle.

14. The container according to claim 13, further comprising at least one shuttle guide axially disposed along the inside surface of said container body, wherein said shuttle further comprises a corresponding shuttle guide receiver arranged to cooperate with said at least one shuttle guide to prevent rotation of said shuttle as said shuttle traverses axially within said container.

15. The container according to claim 11, wherein:
said integral extruding device comprises:
a shaft that passes generally axially through said body, said shaft comprising two drivers interconnected such that a first one of said drivers can reciprocate axially with respect to a second one of said drivers, said second one of said drivers further fixedly secured to second end of said body;
an actuation mechanism coupled to said first one of said drivers external to said body such that axial displacement of said actuation mechanism causes unitary axial displacement of said first one of said drivers with respect to said second one of said drivers; and
a biasing member arranged to bias said actuation mechanism generally axially away from said second end of said body; and
said shuttle comprises:
an aperture therethrough, said shuttle arranged such that said first and second drivers pass through said aperture; and
a plurality of indexing legs extending generally axially outward from said shuttle, arrayed generally circumferentially about said aperture, wherein said shuttle is initially positioned proximate said second end of said body and said actuation mechanism may be operated such that said shuttle indexes generally axially towards said first end of said body until said shuttle reaches a forward most end portion of said shaft, wherein said shaft defines said locking device as said shuttle is prevented from traversing backwards towards said second end of said body.

16. The container according to claim 15, wherein said first and second drivers each comprise indexing steps along the periphery thereof, and wherein said indexing legs of said shuttle are configured to operatively engage said indexing steps to index said shuttle towards said first end of said body in response to actuation of said actuation mechanism.

17. The container according to claim 11, wherein:
said integral extruding device comprises:
a shaft that passes generally axially through said body, said shaft comprising a driver including indexing steps along the periphery thereof;
an actuation mechanism coupled to said driver external to said body such that axial displacement of said actuation mechanism causes unitary axial displacement of said driver; and
a biasing member arranged to bias said actuation mechanism generally axially away from said second end of said body; and
said shuttle comprises:
an aperture therethrough, said shuttle arranged such that said driver passes through said aperture; and
a plurality of indexing legs extending generally axially outward from said shuttle, arrayed generally circumferentially about said aperture, wherein said shuttle is initially positioned proximate said second end of said body and said actuation mechanism may be operated such that said shuttle indexes generally axially towards said first end of said body in cooperation with said indexing steps until said shuttle reaches a forward most end portion of said shaft, wherein said shaft defines said locking device as said shuttle is prevented from traversing backwards towards said second end of said body.

18. The container according to claim 1, further comprising a cap arranged to align said container substantially normal to a work surface and space said discharge aperture from said work surface by a predetermined distance.

19. A method of providing extrudable, flowable material comprising:
providing prepackaged a flowable material in a disposable container, said container provided by:
providing a generally elongate body including a first end having a dispensing aperture and a second end opposite the first end;
providing a cap temporarily secured to said first end sealing said dispensing aperture;
providing a shuttle positioned within said body initially oriented proximate to said second end of said body, said shuttle operative to extrude said flowable material through said dispensing aperture; and
providing a locking device operatively configured to lock said shuttle when said shuttle is advanced to a position within said body proximate to said first end so as to prevent rearward retraction of said shuttle back to said second end of said container.

20. A container with an integral extruder comprising:
a generally elongate body including a first end having a dispensing aperture and a second end opposite said first end;
a flowable material contained within said generally elongate body;
an extruding device comprising:
a shaft that passes generally axially through said body;
an actuation mechanism coupled to said shaft external to said body such that rotation of said actuation mechanism causes unitary rotational motion of said shaft; and
a first locking member arranged on a forwardmost end portion of said shaft within said body; and
a shuttle positioned within said body and operative to extrude said flowable material through said dispensing aperture, said shuttle comprising:
an aperture therethrough, said shuttle arranged such that said shaft passes through said aperture; and
a second locking member generally concentric with said first locking member of said shaft, wherein said shuttle is initially positioned proximate said second end of said body and said actuation mechanism may be operated such that said first locking member on said shaft is brought into cooperative engagement with said second locking member on said shuttle, thereafter said shuttle traverses axially within said body in unitary axial motion with said shaft.

21. The container according to claim 20, further comprising a locking device operatively configured to lock said shuttle when said shuttle is advanced to a position within said body proximate to said first end so as to prevent rearward retraction of said shuttle back to said second end of said container.

22. A container with an integral extruder comprising:
a generally elongate body including a first end having a dispensing aperture and a second end opposite said first end;
a flowable material contained within said generally elongate body;
an extruding device comprising:
a threaded shaft that passes generally axially through said body; and
an actuation mechanism coupled to said shaft external to said body such that rotation of said actuation mechanism causes unitary rotational motion of said shaft, said shaft configured to rotate within said body and is generally inhibited from axial displacement with respect to said body;
a shuttle positioned within said body and operative to extrude said flowable material through said dispensing aperture, said shuttle comprising an aperture therethrough, said shuttle arranged such that said shaft passes through said aperture, wherein said shuttle is initially positioned proximate said second end of said body and said actuation mechanism may be operated such that rotation of said shaft causes axial displacement of said shuttle; and
a locking device operatively configured to lock said shuttle when said shuttle is advanced to a position within said body proximate to said first end so as to prevent rearward retraction of said shuttle back to said second end of said container.

23. The container according to claim 22, further comprising at least one shuttle guide axially disposed along the inside surface of said container body, wherein said shuttle further comprises a corresponding shuttle guide receiver arranged to cooperate with said at least one shuttle guide to prevent rotation of said shuttle as said shuttle traverses axially within said container.

24. A container with an integral extruder comprising:
a generally elongate body including a first end having a dispensing aperture and a second end opposite said first end;
a flowable material contained within said generally elongate body;
an extruding device comprising:
a shaft that passes generally axially through said body, said shaft comprising two drivers interconnected such that a first one of said drivers can reciprocate axially with respect to a second one of said drivers, said second one of said drivers further fixedly secured to second end of said body;
an actuation mechanism coupled to said first one of said drivers external to said body such that axial displacement of said actuation mechanism causes unitary axial displacement of said first one of said drivers with respect to said second one of said drivers; and
a biasing member arranged to bias said actuation mechanism generally axially away from said second end of said body; and
a shuttle positioned within said body initially oriented proximate to said second end of said body, said shuttle operative to extrude said flowable material through said dispensing aperture, said shuttle including an aperture through which said first and second drivers pass, and is configured such that operation of said actuation mechanism causes said shuttle to axially traverse said first and second drivers towards said dispensing aperture.

25. The container according to claim 24, wherein said shuttle further comprises a plurality of indexing legs extending generally axially outward from said shuttle, arrayed generally circumferentially about said aperture, wherein said shuttle is initially positioned proximate said second end of said body and said actuation mechanism may be operated such that said shuttle indexes generally axially towards said first end of said body until said shuttle reaches a forward most end portion of said shaft, wherein said shaft defines said locking device as said shuttle is prevented from traversing backwards towards said second end of said body.

26. The container according to claim 25, wherein said first and second drivers each comprise indexing steps along the periphery thereof, and wherein said indexing legs of said shuttle are configured to operatively engage said indexing steps to index said shuttle towards said first end of said body in response to actuation of said actuation mechanism.

27. A container with an integral extruder comprising:
a generally elongate body including a first end having a dispensing aperture and a second end opposite said first end;
an extruding device comprising:
a shaft that passes generally axially through said body; and
an actuation mechanism coupled to said shaft external to said body such that axial displacement of said actuation mechanism causes unitary axial displacement of said shaft;
a flowable material contained within said generally elongate body; and
a shuttle positioned within said body initially oriented proximate to said second end of said body, said shuttle operative to extrude said flowable material through said dispensing aperture, said shuttle including an aperture therethrough, said shuttle arranged such that said shaft passes through said aperture, wherein said shuttle is operatively configured to cooperate with said shaft such that axial displacement of said shaft towards said dispensing aperture causes said shuttle to axially advance within said container towards said dispensing aperture, and axial retraction of said shaft away from said dispensing aperture does not cause axial retraction of said shuttle away from said dispensing aperture.

28. The container according to claim 27, wherein said shuttle further comprises a plurality of indexing legs extending generally axially outward from said shuttle, arrayed generally circumferentially about said aperture, wherein said shuttle is initially positioned proximate said second end of said body and said actuation mechanism may be operated such that said shuttle indexes generally axially towards said first end of said body in cooperation with said shaft until said shuttle reaches a forward most end portion of said shaft, wherein said shaft defines said locking device as said shuttle is prevented from traversing backwards towards said second end of said body.

29. The container according to claim 27, further comprising a biasing member arranged to bias said actuation mechanism generally axially away from said second end of said body.

30. The container according to claim 27, further comprising a cap arranged to align said container substantially normal to a work surface and space said discharge aperture from said work surface by a predetermined distance.

31. A disposable comestible container comprising:
a generally elongate disposable body including a first end having a dispensing aperture and a second end opposite said first end;
a flowable comestible contained within said generally elongate body;
a shuttle positioned within said body initially oriented proximate to said second end of said body, said shuttle operative to extrude said flowable comestible through said dispensing aperture; and
a plurality of templates temporarily stored on said body, a select one of said plurality of templates positionable over said dispensing aperture such that when said shuttle is advanced to dispense said comestible from said body, said comestible passes through said select one of said plurality of templates to provide a decoratively shaped food product.

32. The disposable comestible container according to claim 31, wherein said plurality of templates is stored behind said shuttle.

33. The disposable comestible container according to claim 31, wherein said plurality of templates is stored between said dispensing aperture and a cap temporarily positioned over said dispensing aperture when said comestible container is not in use.
